(19) United States
(12) Patent Application Publication
(10) Pub. No.: US 2026/0302750 A1
(43) Pub. Date: Oct. 1, 2026

(54) WIRING MEMBER FIXING DEVICE, WIRE HARNESS, AND WIRING MEMBER FIXING METHOD

(71) Applicant: Yazaki Corporation, Tokyo (JP)

(72) Inventors: Noriyuki HANAZUMI, Tochigi (JP); Genki FURUYA, Tochigi (JP); Hiroyasu FURUYA, Tochigi (JP)

(73) Assignee: Yazaki Corporation, Tokyo (JP)

(21) Appl. No.: 19/549,110

(22) Filed: Feb. 25, 2026

(30) Foreign Application Priority Data
Mar. 26, 2025 (JP) 2025-050931

(51) Int. Cl. H02G 3/32

(52) U.S. Cl. CPC H02G 3/32

(57) ABSTRACT

A wiring member fixing device includes a protector including a protector main body, a protector cover, and a protector-side lock portion that locks the protector main body and the protector cover, and a clamp including a clamp main body attached to an outer periphery of the protector main body and provided with a support portion that supports the outer periphery of the protector main body so as to regulate a relative position around an axis of the protector main body in an extending direction of a wiring member, a clamp cover, and a clamp-side lock portion that locks the clamp main body and the clamp cover, in which the protector-side lock portion and the clamp-side lock portion are arranged to be aligned in position around the axis.

### CROSS-REFERENCE TO RELATED APPLICATION(S)

The present application claims priority to and incorporates by reference the entire contents of Japanese Patent Application No. 2025-050931 filed in Japan on Mar. 26, 2025.

### BACKGROUND OF THE INVENTION

### 1. Field of the Invention

The present invention relates to a wiring member fixing device, a wire harness, and a wiring member fixing method.

### 2. Description of the Related Art

As a technique related to a conventional wiring member fixing device, a conventional wire harness, and a conventional wiring member fixing method, for example, Japanese Patent Application Laid-open No.JP 2024 – 107 537 A discloses a wiring member fixing device, a wire harness, and a wiring member fixing method. The wiring member fixing device includes a protector attached to an outer periphery of a bent pipe and a straight pipe that accommodate an electric wire as a wiring member, and a clamp attached to the protector so as to be capable of sliding movement in an extending direction of the electric wire and rotational movement with the extending direction as a rotation center and fixed to a vehicle, in which the protector includes a movement restriction unit that restricts a movement region of sliding movement of the clamp.

Meanwhile, in such a wiring member fixing device, a wire harness, and a wiring member fixing method, for example, when the wiring member fixing device is fixed to an object to be fixed, it may be difficult to visually recognize a lock portion of a cover provided on a clamp or a protector, and it may take time to confirm that the lock portion is reliably locked. In this respect, the wiring member fixing device, the wire harness, and the wiring member fixing method have room for further improvement in the configuration of attaching the clamp to the protector.

### SUMMARY OF THE INVENTION

The present invention has been made in view of the above-described circumstances, and an object thereof is to provide a wiring member fixing device, a wire harness, and a wiring member fixing method with improved assembly workability.

In order to achieve the above mentioned object, a wiring member fixing device according to one aspect of the present invention includes a protector including a protector main body having an open protector opening portion, the protector main body being configured for a wiring member to be inserted therethrough, a protector cover provided on the protector main body via a hinge portion in an openable-and-closable manner so as to cover the protector opening portion, and a protector-side lock portion configured to lock the protector main body and the protector cover; and a clamp including a clamp main body provided with a fixing portion fixed to an object to be fixed, the clamp main body having an open clamp opening portion, the clamp main body being attached to an outer periphery of the protector main body, the clamp main body including a support portion configured to support the outer periphery of the protector main body so as to regulate a relative position around an axis of the protector main body in an extending direction of the wiring member, a clamp cover provided on the clamp main body via a hinge portion in an openable-and-closable manner so as to cover the clamp opening portion, and a clamp-side lock portion configured to lock the clamp main body and the clamp cover, wherein the protector-side lock portion and the clamp-side lock portion are arranged to be aligned in position around the axis.

In order to achieve the above mentioned object, a wire harness according to another aspect of the present invention includes a wiring member having conductivity; and a wiring member fixing device configured to fix the wiring member to an object to be fixed, wherein the wiring member fixing device includes a protector including a protector main body having an open protector opening portion, the protector main body being configured for the wiring member to be inserted therethrough, a protector cover provided on the protector main body via a hinge portion in an openable-and-closable manner so as to cover the protector opening portion, and a protector-side lock portion configured to lock the protector main body and the protector cover, and a clamp including a clamp main body provided with a fixing portion fixed to the object to be fixed, the clamp main body having an open clamp opening portion, the clamp main body being attached to an outer periphery of the protector main body, the clamp main body including a support portion configured to support the outer periphery of the protector main body so as to regulate a position around an axis of the protector main body in an extending direction of the wiring member, a clamp cover provided on the clamp main body via a hinge portion in an openable-and-closable manner so as to cover the clamp opening portion, and a clamp-side lock portion configured to lock the clamp main body and the clamp cover, and the protector-side lock portion and the clamp-side lock portion are arranged to be aligned in position around the axis.

In order to achieve the above mentioned object, a wiring member fixing method according to still another aspect of the present invention includes a protector attachment step of placing, on a jig plate, a protector including a protector main body having an open protector opening portion, the protector main body being configured for a wiring member to be inserted therethrough, inserting the wiring member through the protector main body from the protector opening portion, closing a protector cover provided on the protector main body via a hinge portion in an openable-and-closable manner to cover the protector opening portion, and locking the protector main body and the protector cover with a protector-side lock portion provided on the protector; and a clamp attachment step of inserting the protector main body of the protector from a clamp opening portion formed to be open in a clamp main body of a clamp to attach the clamp main body to the protector main body, supporting an outer periphery of the protector main body by a support portion provided in the clamp main body so as to regulate a position around an axis of the protector main body in an extending direction of the wiring member, closing a clamp cover provided on the clamp main body via a hinge portion in an openable-and-closable manner to cover the clamp opening portion, locking the clamp main body and the clamp cover by a clamp-side lock portion provided in the clamp, and arranging the protector-side lock portion and the clamp-side lock portion to be aligned in position around the axis.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a wiring member fixing device according to an embodiment;

FIG. 2 is an exploded perspective view illustrating the wiring member fixing device according to the embodiment in a state in which a protector cover and a clamp cover are opened;

FIG. 3 is a perspective view illustrating a protector according to the embodiment in a state in which the protector cover is closed;

FIG. 4 is a cross-sectional view taken along a line IV-IV of FIG. 1, illustrating members other than a wiring member in cross section;

FIG. 5 is a cross-sectional view taken along a line V-V of FIG. 1;

FIG. 6 is a flowchart illustrating a wiring member fixing method according to the embodiment;

FIG. 7 is a perspective view for description of the wiring member fixing method according to the embodiment;

FIG. 8 is a perspective view for description of the wiring member fixing method according to the embodiment; and

FIG. 9 is a side view for description of the wiring member fixing method according to the embodiment.

### DETAILED DESCRIPTION OF THE PREFERRED EMBODIMENTS

Hereinafter, an embodiment according to the present invention will be described in detail with reference to the drawings. It is noted that the present invention is not limited by the embodiment. In addition, components in the following embodiment include those that can be easily replaced by those skilled in the art or those that are substantially the same.

### Embodiment

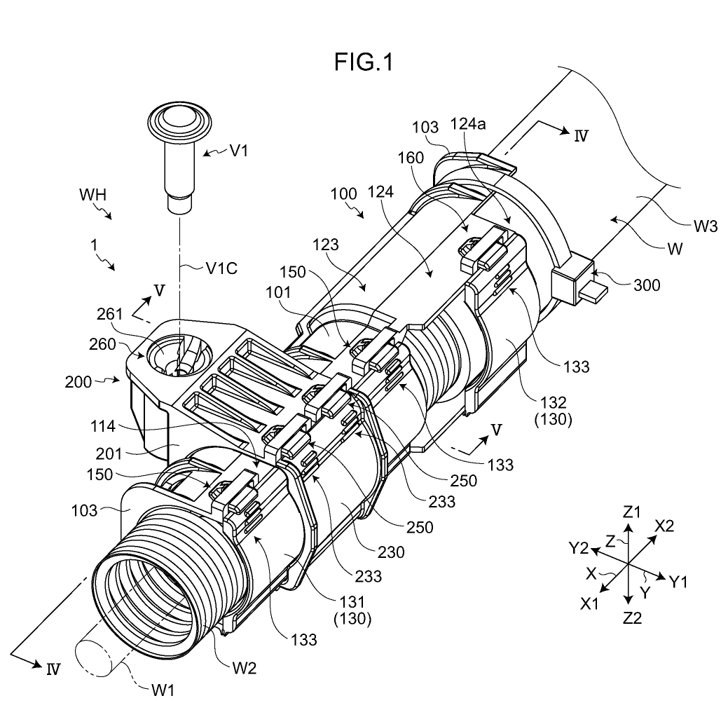

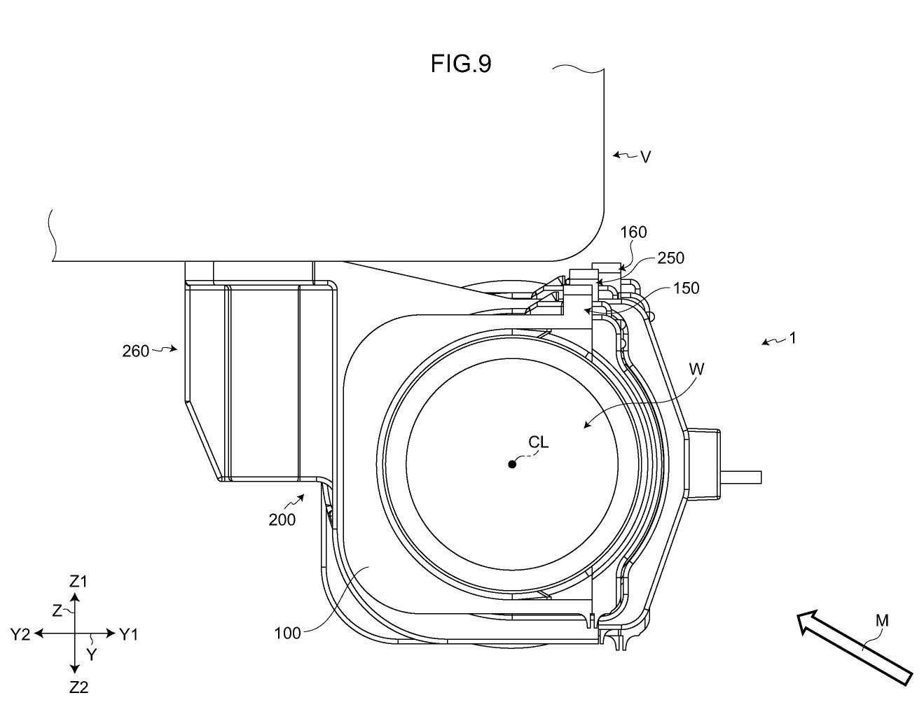

FIG. 1 is a perspective view of a wire harness WH to which a wiring member fixing device 1 according to the present embodiment is applied. The wire harness WH of the present embodiment illustrated in FIG. 1 is routed in a vehicle such as an automobile, and the wiring member fixing device 1 is incorporated therein. Here, for example, the wire harness WH is configured such that a plurality of electric wires W1 used for power supply and signal communication are bundled to form a collective component for connection between devices mounted on a vehicle, and a wiring member W including the plurality of electric wires W1 and having conductivity is connected to each device by a connector or the like. The wiring member W includes the electric wire W1, a corrugated pipe W2, and a straight pipe W3. The wire harness WH of the present embodiment includes the wiring member W and the wiring member fixing device 1 that fixes the wiring member W to an object to be fixed V (refer to FIG. 9). The wire harness WH may further include various components such as a grommet, an electrical connection box, and a fixing tool.

The electric wire W1 of the wiring member W is, for example, a sheathed electric wire in which an outer periphery of a linear conductive member is covered with an insulating sheath. The electric wire W1 may be configured as, for example, an electric wire bundle obtained by bundling a plurality of sheathed electric wires. The corrugated pipe W2 is a bellows-shaped pipe body externally mounted on the electric wire W1. The straight pipe W3 is a pipe body formed of a material having a strength higher than that of the corrugated pipe W2 and extending in a linear shape.

The object to be fixed V is, for example, a vehicle body of a vehicle, a member to be attached to the vehicle body, a component, or the like, and forms a bar-shaped member V1 such as a stud bolt. The wiring member fixing device 1 is fixed to the object to be fixed V via the bar-shaped member V1.

In the following description, a direction in which the wiring member W extends is referred to as an extending direction X, and two directions that are orthogonal to and intersect the extending direction X are referred to as a width direction Y and a height direction Z. The height direction Z is a direction along an axis V1C of the bar-shaped member V1. In the following description, one side in the extending direction X is referred to as one side X1, and the other side is referred to as the other side X2. Similarly, a description will be given assuming that, regarding the width direction Y, one side Y1 and the other side Y2 are defined, and regarding the height direction Z, one side Z1 and the other side Z2 are defined.

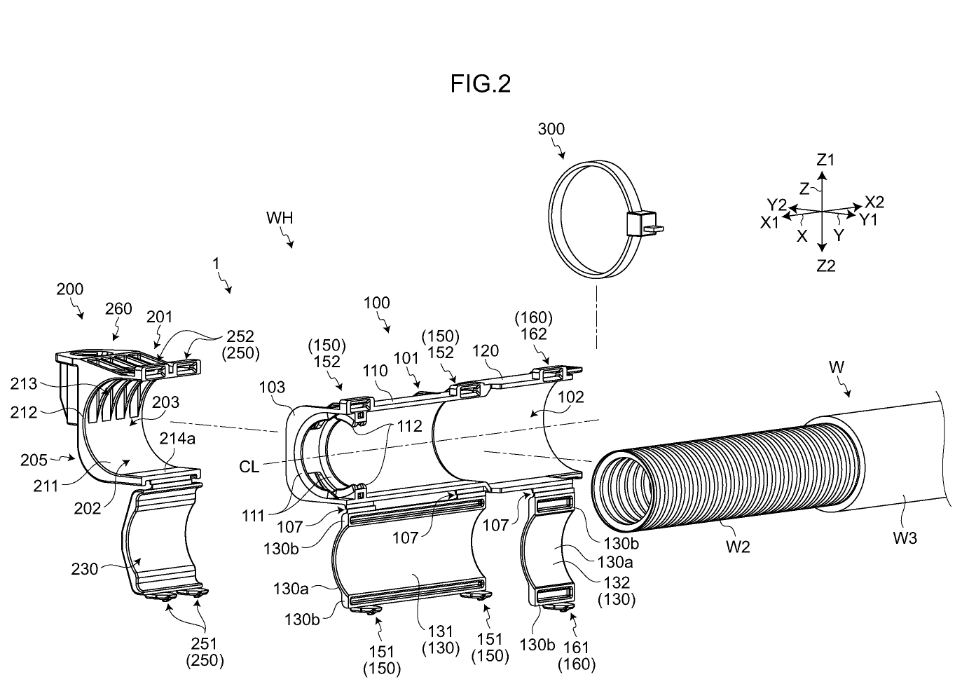

The wiring member fixing device 1 includes a protector 100 and a clamp 200. The protector 100 protects the wiring member W routed inside and is fixed to the object to be fixed V via the clamp 200 to regulate a routing path of the wiring member W. As illustrated in FIG. 2, the protector 100 includes a protector main body 101 through which the wiring member W is inserted, a protector cover 130, and a protector-side lock portion 150. The protector main body 101 has a protector opening portion 102 in which a part around an axis CL of the protector main body 101 in the extending direction X is open, and is formed in a substantially cylindrical shape having a substantially C annular shape when viewed from the extending direction X. The protector cover 130 is provided so as to cover the protector opening portion 102.

The protector main body 101 is provided with a corrugated pipe arrangement portion 110 disposed outside the corrugated pipe W2 on one side X1 in the extending direction X. On the other side X2 in the extending direction X of the corrugated pipe arrangement portion 110, a straight pipe arrangement portion 120 disposed outside the straight pipe W3 of the wiring member W is provided. An inner diameter of the straight pipe arrangement portion 120 is formed to be larger than an inner diameter of the corrugated pipe arrangement portion 110.

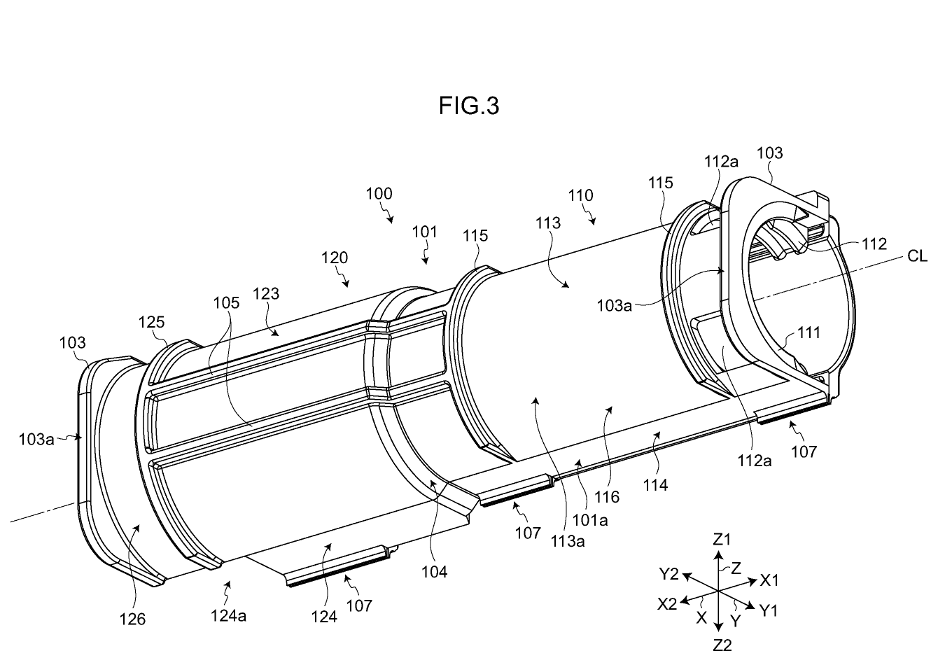

On an inner peripheral surface of the corrugated pipe arrangement portion 110 on one side X1 in the extending direction X, two C annular ribs 111 protruding in an inner diameter direction are provided. Among the two C annular ribs 111, one C annular rib 111 is formed on an inner peripheral surface of the protector main body 101 at an end on one side X1 in the extending direction X. Small rib portions 112 are provided between the two C annular ribs 111 in the extending direction X. The small rib portions 112 are provided on the inner peripheral surface of the corrugated pipe arrangement portion 110 so as to face each other in the height direction Z. Each of the small rib portions 112 is provided with two arc-shaped ribs along the inner peripheral surface of the corrugated pipe arrangement portion 110. Each of the two C annular ribs 111 and the two small rib portions 112 fits into the groove of the corrugated pipe W2 to restrict movement of the corrugated pipe W2 in the extending direction X. As illustrated in FIG. 3, two through holes 112a for molding the respective small rib portions 112 are provided in an arc-shaped portion 113 to be described later of the protector main body 101 at positions corresponding to radially outward directions of the respective small rib portions 112.

As illustrated in FIG. 3, two placement ribs 103 are respectively provided on one side X1 and the other side X2 in the extending direction X of an outer periphery 101a of the protector main body 101. The placement ribs 103 are provided at two places with a predetermined interval therebetween in the extending direction X. The placement rib 103 is formed in a substantially long rectangular shape with a plate surface oriented in the extending direction X. Each placement rib 103 is formed with a long side portion 103a in the height direction Z.

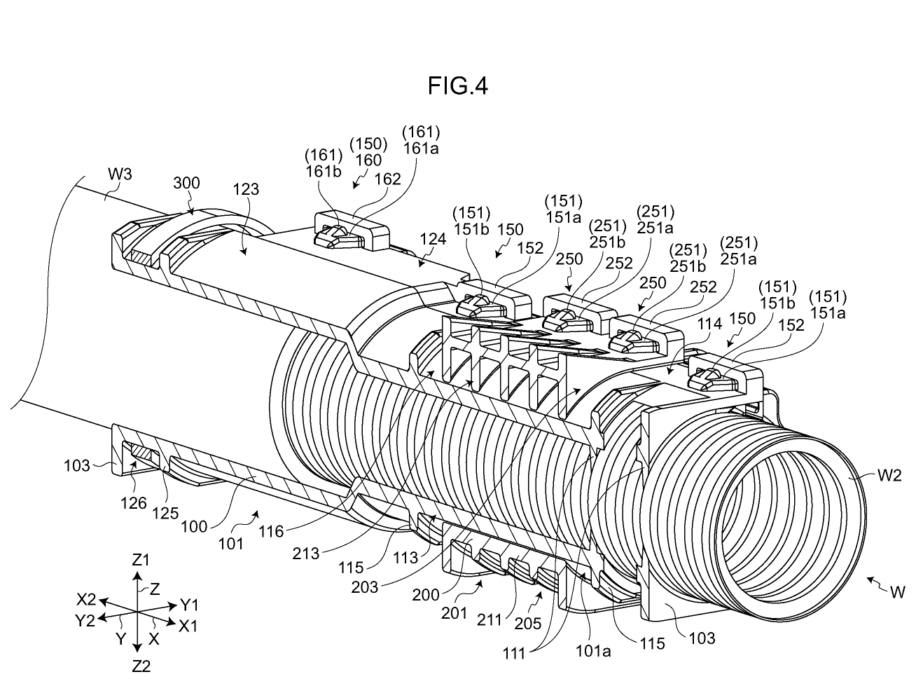

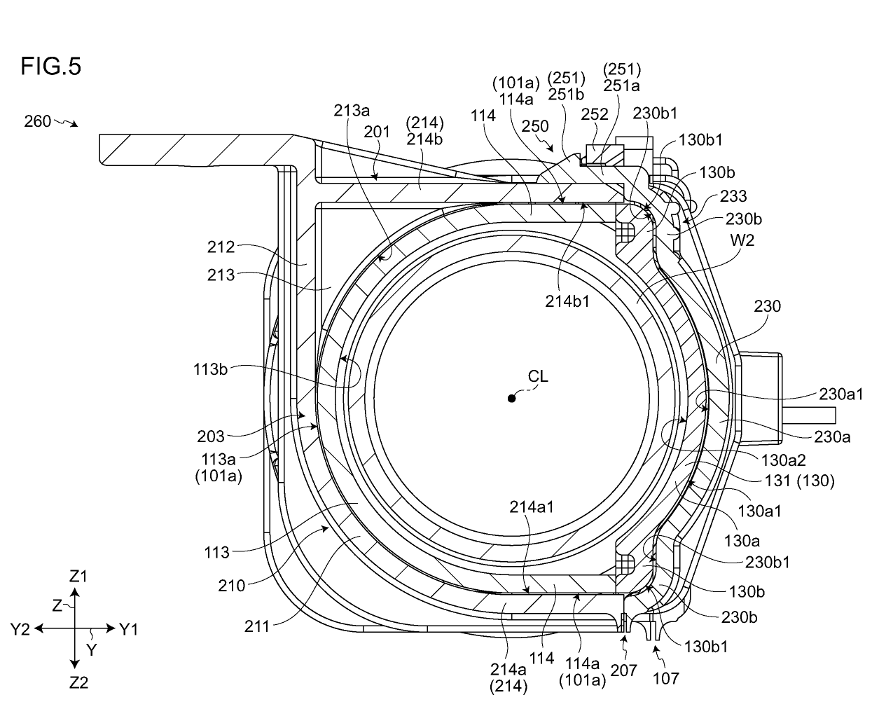

The corrugated pipe arrangement portion 110 of the protector main body 101 is provided with the arc-shaped portion 113 formed in an arc shape around the axis CL when viewed in the extending direction X and two restriction surface portions 114 formed in a flat surface shape in the height direction Z (also refer to FIGS. 4 and 5). As illustrated in FIG. 5, an outer periphery 113a and an inner periphery 113b of the arc-shaped portion 113 are substantially arcuate when viewed in the extending direction X. A curvature of the inner periphery 113b of the arc-shaped portion 113 is formed to be equal to a curvature of an outermost diameter of the corrugated pipe W2. Each of the restriction surface portions 114 is connected to the arc-shaped portion 113. The restriction surface portions 114 are provided at two places facing each other in the height direction Z. In each of the restriction surface portions 114, at least an outer periphery 114a that is an outer surface is formed in a flat surface shape. The outer periphery 101a of the protector main body 101 includes the outer periphery 114a of the restriction surface portion 114 and the outer periphery 113a of the arc-shaped portion 113.

As illustrated in FIG. 3, the straight pipe arrangement portion 120 of the protector main body 101 is provided with an arc-shaped portion 123 formed in an arc shape around the axis CL and two flat surface portions 124 formed in a flat surface shape in the height direction Z (also refer to FIG. 4). An outer periphery and an inner periphery of the arc-shaped portion 123 are substantially arcuate when viewed in the extending direction X. The inner periphery of the arc-shaped portion 123 is formed with a curvature equivalent to an outer diameter of the straight pipe W3. Each flat surface portion 124 is connected to the arc-shaped portion 123. The two flat surface portions 124 are provided to face each other in the height direction Z.

As illustrated in FIG. 3, the arc-shaped portion 113 and the two restriction surface portions 114 of the corrugated pipe arrangement portion 110 are respectively connected to the arc-shaped portion 123 and the two flat surface portions 124 of the straight pipe arrangement portion 120 via a stepped portion 104. A length of each flat surface portion 124 in the extending direction X is formed to be shorter than a length of the arc-shaped portion 123 in the extending direction X. Therefore, on the other side X2 in the extending direction X of the straight pipe arrangement portion 120 (each flat surface portion 124), a cutout portion 124a is formed by cutting out each flat surface portion 124 (also refer to FIG. 1).

As illustrated in FIG. 3, on the outer periphery 113a of the arc-shaped portion 113 of the corrugated pipe arrangement portion 110 of the protector main body 101, two restriction ribs 115 each having an arc shape when viewed in the extending direction X and protruding radially outward from the outer periphery 113a of the arc-shaped portion 113 are provided. The two restriction ribs 115 are provided with a predetermined interval therebetween in the extending direction X. The two restriction ribs 115 restrict attachment positions of the clamp 200 in the extending direction X. The restriction rib 115 on one side X1 in the extending direction X is disposed closer to the other side X2 than to the placement rib 103 on the one side X1. A clamp arrangement portion 116 is formed between the two restriction ribs 115 on the outer periphery 113a of the arc-shaped portion 113. In other words, the clamp arrangement portion 116 is provided between the placement ribs 103.

As illustrated in FIG. 3, a guide rib 125 is provided on the outer periphery of the straight pipe arrangement portion 120 of the protector main body 101 on the other side X2 in the extending direction X. The guide rib 125 is formed to protrude radially outward from the outer periphery of the arc-shaped portion 123 of the straight pipe arrangement portion 120. The guide rib 125 is disposed closer to one side X1 than to the placement rib 103 on the other side X2 in the extending direction X. The position of the guide rib 125 in the extending direction X is located in a range of the cutout portion 124a in the extending direction X. A binding band attachment portion 126 around which a binding band 300 is wound is formed between the placement rib 103 and the guide rib 125 on the other side X2 in the extending direction X. Between the restriction rib 115 and the guide rib 125 on the other side X2 in the extending direction X, two reinforcement ribs 105 are provided from the arc-shaped portion 123 to the arc-shaped portion 113 via the stepped portion 104.

As illustrated in FIG. 2, the protector cover 130 is provided on the protector main body 101 via a hinge portion 107 in an openable-and-closable manner so as to cover the protector opening portion 102. In the present embodiment, the hinge portion 107 is provided in a thin plate shape and has a direction along the axis CL as a rotation axis thereof. The protector cover 130 includes a first protector cover 131 provided in the corrugated pipe arrangement portion 110 and a second protector cover 132 provided in the straight pipe arrangement portion 120. Both the first protector cover 131 and the second protector cover 132 are each formed in a substantially arc shape when viewed in the extending direction X. More specifically, each of the first protector cover 131 and the second protector cover 132 includes an arc-shaped portion 130a having a substantially arc shape, and flat plate portions 130b provided to protrude in a flat plate shape from both ends of the arc-shaped portion 130a. As illustrated in FIG. 5, a curvature of an inner periphery 130a2 of the arc-shaped portion 130a of the first protector cover 131 is equal to the curvature of the outermost diameter of the corrugated pipe W2. Similarly, a curvature of an inner periphery of the arc-shaped portion 130a of the second protector cover 132 is equal to the curvature of the outer diameter of the straight pipe W3.

As illustrated in FIG. 2, the first protector cover 131 is formed to have a length in the extending direction X of the corrugated pipe arrangement portion 110. One edge portion (in FIG. 5, the flat plate portion 130b on the other side Z2 in the height direction Z) of the first protector cover 131 in the extending direction X is connected to the restriction surface portion 114 on the other side Z2 in the height direction Z via the hinge portion 107. Two locking portions 151 are provided at the other edge portion (in FIG. 5, the flat plate portion 130b on one side Z1 in the height direction Z) of the first protector cover 131 in the extending direction X. The two locking portions 151 are provided at an end on one side X1 and an end on the other side X2 in the extending direction X of the first protector cover 131, respectively. As illustrated in FIG. 4, the locking portion 151 includes a flat plate-shaped insertion plate portion 151a and a locking protrusion 151b protruding from a plate surface of the insertion plate portion 151a. Meanwhile, a locked portion 152 is provided on the outer periphery 114a of the restriction surface portion 114 on one side Z1 in the height direction Z of the corrugated pipe arrangement portion 110. The locked portion 152 is formed in a frame shape. The insertion plate portion 151a and the locking protrusion 151b of the locking portion 151 are inserted inside the frame shape of the locked portion 152, and the locking protrusion 151b is locked to the locked portion 152. The locking portion 151 and the locked portion 152 constitute the protector-side lock portion 150. The protector-side lock portion 150 (and a straight pipe-side lock portion 160 to be described later) is provided at an opening edge of the protector opening portion 102.

As illustrated in FIG. 2, the second protector cover 132 is formed to be shorter than the length of the straight pipe arrangement portion 120 in the extending direction X, and is formed to cover a part of the protector opening portion 102 corresponding to the straight pipe arrangement portion 120. As illustrated in FIG. 3, the second protector cover 132 is connected to the flat surface portion 124 on the other side Z2 in the height direction Z via the hinge portion 107. Similarly to the first protector cover 131, the second protector cover 132 is provided with a locking portion 161 (insertion plate portion 161a and locking protrusion 161b). As illustrated in FIG. 4, a frame-shaped locked portion 162 is provided on the flat surface portion 124 on one side Z1 of the straight pipe arrangement portion 120 in the height direction Z. The second protector cover 132 abuts on an outer periphery of the straight pipe W3 and sandwiches the wiring member W together with an inner peripheral surface of the straight pipe arrangement portion 120. The locking portion 161 and the locked portion 162 constitute the straight pipe-side lock portion 160. The protector-side lock portion 150 includes the straight pipe-side lock portion 160.

As illustrated in FIG. 1, in the first protector cover 131 and the second protector cover 132, a plurality of ridges 133 extending in the extending direction X are provided on an outer surface of the flat plate portion 130b on the side where the locking portions 151 and 161 constituting the protector-side lock portion 150 and the straight pipe-side lock portion 160 are provided. The ridges 133 serve as marks indicating positions of the protector-side lock portion 150 and the straight pipe-side lock portion 160. Similarly, ridges 233 formed in the same manner as the ridges 133 are provided on a clamp cover 230 so as to indicate a position of a clamp-side lock portion 250 to be described later.

As illustrated in FIG. 1, the clamp 200 includes a clamp main body 201 and the clamp cover 230. As illustrated in FIG. 2, the clamp main body 201 is provided with a fixing portion 260 to be fixed to the object to be fixed V, and is attached to the outer periphery 101a of the protector main body 101 with an open clamp opening portion 202. As illustrated in FIG. 5, the clamp main body 201 is provided with an arc-shaped portion 211 formed in a substantially arc shape when viewed in the extending direction X in a range of about 90 degrees from the other side Z2 in the height direction Z to the other side Y2 in the width direction Y around the axis CL. A curvature of an inner peripheral surface of the arc-shaped portion 211 is equal to the curvature of the outer periphery 113a of the arc-shaped portion 113 of the protector main body 101. On one side Z1 in the height direction Z of the arc-shaped portion 211, a flat plate-shaped bottom plate portion 212 that is connected to the arc-shaped portion 211 and has a flat plate-shaped surface oriented in the width direction Y is provided. On one side Y1 in the width direction Y of the arc-shaped portion 211, a flat plate-shaped side plate 214a that is connected to the arc-shaped portion 211 and has a plate surface oriented in the height direction Z is provided. Further, on one side Z1 of the bottom plate portion 212 in the height direction Z, a side plate 214b that is connected to the bottom plate portion 212 and has a plate surface oriented in the height direction Z is provided. The side plates 214a and 214b are each an abutment support surface portion 214.

In addition, as illustrated in FIG. 5, at a corner portion where the bottom plate portion 212 and the side plate 214b of the clamp main body 201 intersect at a substantially right angle, a plurality of arc-shaped support ribs 213 are provided across the bottom plate portion 212 and the side plate 214b with the plate surface oriented in the extending direction X (also refer to FIGS. 2 and 4). An inner edge of the arc-shaped support rib 213 is formed with a curvature equivalent to an inner periphery of the arc-shaped portion 211, and is formed as a support surface 213a substantially continuous with the inner periphery of the arc-shaped portion 211. The arc-shaped support rib 213 having the support surface 213a and the arc-shaped portion 211 constitute an arc-shaped support portion 210. In addition, the clamp main body 201 includes a support portion 203 that supports the outer periphery 101a of the protector main body 101 so as to regulate a relative position of the protector main body 101 with respect to the clamp main body 201 around the axis CL. In the present embodiment, the support portion 203 includes the arc-shaped support portion 210 and the abutment support surface portion 214. The support portion 203 supports the outer periphery 101a of the protector main body 101 in the clamp arrangement portion 116. The abutment support surface portions 214 are provided at two places facing each other in the height direction Z.

As illustrated in FIG. 5, on the other side Y2 in the width direction Y of the bottom plate portion 212, the fixing portion 260 to be fixed to the object to be fixed V is provided. As illustrated in FIG. 1, the fixing portion 260 is provided with a fixing hole portion 261 configured for the bar-shaped member V1 to be inserted thereinto and fixed therein. As illustrated in FIG. 4, a plurality of ribs 205 are provided on the outer periphery of the clamp main body 201.

As illustrated in FIG. 2, the clamp 200 is provided with the clamp cover 230. The clamp cover 230 is provided on the clamp main body 201 via a hinge portion 207 in an openable-and-closable manner so as to cover the clamp opening portion 202. In the present embodiment, the hinge portion 207 is provided in a thin plate shape and has a direction along the axis CL as a rotation axis thereof. The clamp cover 230 is formed to have a length in the extending direction X of the clamp main body 201.

As illustrated in FIG. 5, the clamp cover 230 is closed so as to cover the protector cover 130. The clamp cover 230 is provided with an arc-shaped cover portion 230a formed in an arc shape when viewed in the extending direction X, and cover edge portions 230b at two places formed at edge portions of the arc-shaped cover portion 230a in the extending direction X. At least an inner periphery 230a1 of the arc-shaped cover portion 230a is formed with a curvature equivalent to that of an outer periphery 130a1 of the arc-shaped portion 130a of the protector cover 130. An inner periphery 230b1 of each cover edge portion 230b is formed to follow an outer periphery 130b1 of the flat plate portion 130b of the corresponding protector cover 130.

Referring also to FIGS. 2 and 5, the cover edge portion 230b (in FIG. 5, the cover edge portion 230b on the other side Z2 in the height direction Z) on one side of the clamp cover 230 is connected to the clamp main body 201 via the hinge portion 207. Two locking portions 251 are provided at the cover edge portion 230b (in FIG. 5, the cover edge portion 230b on one side Z1 in the height direction Z) on the other side of the clamp cover 230. The two locking portions 251 are provided on one side X1 and the other side X2 of the clamp cover 230 in the extending direction X, respectively. As illustrated in FIG. 4, the locking portion 251 includes a flat plate-shaped insertion plate portion 251a and a locking protrusion 251b protruding from a plate surface of the insertion plate portion 251a. On the other hand, a locked portion 252 is provided on an outer peripheral edge on the clamp opening portion 202 side in the side plate 214b on one side Z1 in the height direction Z of the clamp main body 201. The locked portion 252 is formed in a frame shape. The insertion plate portion 251a and the locking protrusion 251b of the locking portion 251 are inserted inside the frame shape of the locked portion 252, and the locking protrusion 251b is locked to the locked portion 252. The locking portion 251 and the locked portion 252 constitute the clamp-side lock portion 250. The clamp-side lock portion 250 is provided at an opening edge of the clamp opening portion 202.

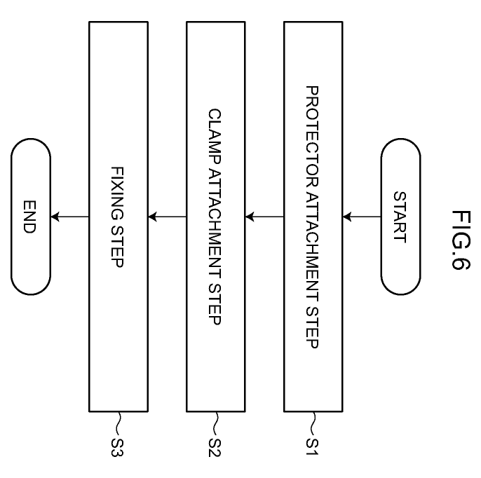

Next, a wiring member fixing method using the wiring member fixing device 1 will be described. As illustrated in FIG. 6, the wiring member fixing method includes a protector attachment step (Step S1), a clamp attachment step (Step S2), and a fixing step (Step S3).

In the protector attachment step (Step S1), the protector 100 including the protector main body 101 having the open protector opening portion 102 into which a wiring member is inserted is placed on a jig plate BJ, the wiring member W is inserted into the protector main body 101 from the protector opening portion 102, the protector cover 130 provided in the protector main body 101 via the hinge portion 107 in an openable-and-closable manner is closed to cover the protector opening portion 102, and the protector main body 101 and the protector cover 130 are locked by the protector-side lock portion 150 provided in the protector 100.

In the clamp attachment step (Step S2), the protector main body 101 of the protector 100 is inserted from the clamp opening portion 202 that is open in the clamp main body 201 of the clamp 200, the clamp main body 201 is attached to the protector main body 101, the outer periphery 101a of the protector main body 101 is supported by the support portion 203 provided in the clamp main body 201 so as to regulate the position of the protector main body 101 around the axis CL in the extending direction X of the wiring member W, the clamp cover 230 provided in the clamp main body 201 via the hinge portion 207 in an openable-and-closable manner is closed to cover the clamp opening portion 202, the clamp main body 201 and the clamp cover 230 are locked by the clamp-side lock portion 250 provided in the clamp 200, and the protector-side lock portion 150 and the clamp-side lock portion 250 are arranged to be aligned in position around the axis CL.

On the outer periphery 101a of the protector main body 101, the rectangular-shaped placement ribs 103 having the plate surfaces oriented in the extending direction X are provided at two places with a predetermined interval therebetween in the extending direction X, and in the protector attachment step (Step S1), the placement ribs 103 are caused to abut on the jig plate BJ, and the protector 100 is placed on the jig plate BJ with the protector opening portion 102 facing the opposite side of the jig plate BJ.

The wiring member fixing method is specifically described as follows.

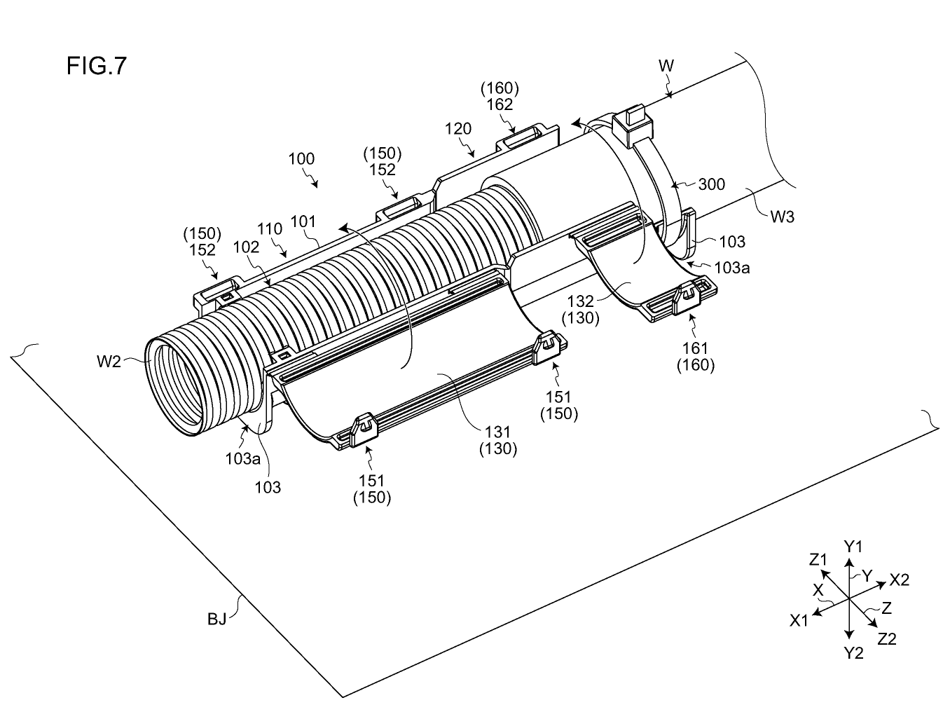

Protector attachment step (Step S1); referring to FIG. 7, in the protector attachment step (Step S1), first, the protector 100 is placed on the flat plate-shaped jig plate BJ in a state in which the protector cover 130 is opened. At this time, the long side portion 103a of the placement rib 103 is caused to abut on the jig plate BJ. Then, the protector opening portion 102 of the protector 100 is disposed upward (on the opposite side of the jig plate BJ). Therefore, the wiring member W is easily inserted into the protector 100 from the protector opening portion 102. Note that the corrugated pipe W2 is partially exposed in the wiring member W, and the exposed corrugated pipe W2 is disposed in the corrugated pipe arrangement portion 110 of the protector 100. The straight pipe W3 of the wiring member W is disposed in the straight pipe arrangement portion 120 of the protector 100.

After the wiring member W is inserted into the protector 100, the binding band 300 is wound around and attached to the outer periphery of the straight pipe W3 from the binding band attachment portion 126 of the protector 100. Then, the first protector cover 131 and the second protector cover 132 are closed, and an opening/closing operation of the first protector cover 131 and the second protector cover 132 is locked by the protector-side lock portion 150. At this time, in the corrugated pipe arrangement portion 110, the corrugated pipe W2 of the wiring member W having a substantially circular outer shape is sandwiched between the first protector cover 131 (arc-shaped portion 130a) and the arc-shaped portion 113. In the straight pipe arrangement portion 120, the straight pipe W3 of the wiring member W is sandwiched between the second protector cover 132 (arc-shaped portion 130a) and the arc-shaped portion 123. Attachment of the binding band 300 may be performed after the first protector cover 131 and the second protector cover 132 are closed.

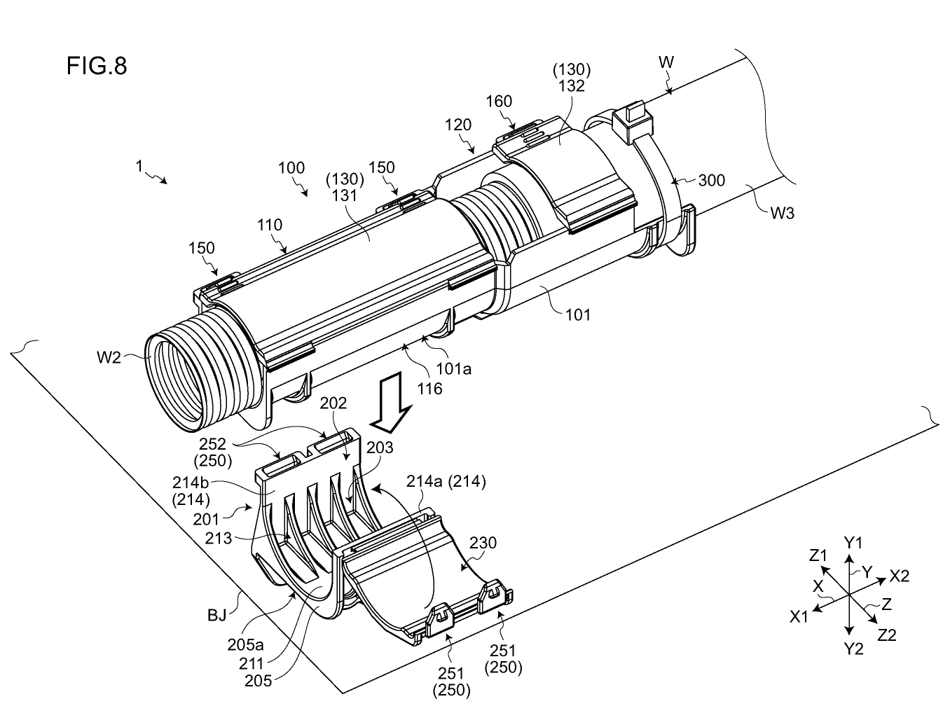

Clamp attachment step (Step S2); referring to FIG. 8, in the clamp attachment step (Step S2), first, the clamp 200 with the clamp cover 230 opened is placed on the jig plate BJ. At this time, the plurality of ribs 205 (slightly large ribs 205 on one side X1 and the other side X2 in the extending direction X) and the fixing portion 260 provided in the clamp main body 201 are placed on the jig plate BJ, and the clamp opening portion 202 of the clamp main body 201 is oriented approximately upward. Then, the protector 100 through which the wiring member W is inserted is inserted into the clamp 200 from the clamp opening portion 202. The clamp 200 is attached to the clamp arrangement portion 116 of the protector 100. At this time, the outer periphery 101a of the protector main body 101 is supported by the support portion 203 including the arc-shaped support portion 210 and the abutment support surface portion 214 of the clamp 200. Then, the clamp cover 230 is closed, and an opening/closing operation of the clamp cover 230 is locked by the clamp-side lock portion 250. At this time, the protector 100 is sandwiched between the support portion 203 of the clamp main body 201 and the clamp cover 230 (arc-shaped cover portion 230a).

Here, when the protector 100 is inserted into the clamp 200, inner peripheries 214a1 and 214b1 (refer to FIG. 5) that are inner surfaces of the side plates 214a and 214b that are the abutment support surface portions 214 of the clamp main body 201 slide on the outer peripheries 114a of two restriction surface portions 114 that are the outer peripheries 101a of the protector main body 101. As a result, the clamp 200 is positioned around the axis CL of the protector 100. Thereafter, the arc-shaped support portion 210 abuts on and supports the outer periphery 113a of the arc-shaped portion 113 of the protector main body 101. Then, as illustrated in FIG. 9, the protector-side lock portion 150 including the straight pipe-side lock portion 160 and the clamp-side lock portion 250 are arranged to be aligned in position around the axis CL. Arranging the protector-side lock portion 150 including the straight pipe-side lock portion 160 and the clamp-side lock portion 250 to be aligned in position around the axis CL includes arranging the protector-side lock portion 150 including the straight pipe-side lock portion 160 and the clamp-side lock portion 250 close to each other around the axis CL.

Fixing step (Step S3); referring to FIG. 9, the wiring member fixing device 1 is fixed to the object to be fixed V such as a vehicle via the fixing portion 260. At this time, the position of the clamp 200 in the extending direction X can be moved within a range where the rib 205 abuts on the restriction rib 115 (refer to FIG. 4). Accordingly, it is possible to absorb attachment tolerance to the object to be fixed V. Since the protector-side lock portion 150 including the straight pipe-side lock portion 160 and the clamp-side lock portion 250 are aligned in position around the axis CL, a worker can easily visually recognize and confirm the above-mentioned portions from a viewing direction M. That is, for example, the positions of the protector-side lock portion 150 including the straight pipe-side lock portion 160 and the clamp-side lock portion 250 around the axis CL are set to positions visible from the viewing direction M of the worker. As a result, the worker can easily confirm that the protector-side lock portion 150 including the straight pipe-side lock portion 160 and the clamp-side lock portion 250 are securely locked.

The wiring member fixing device 1 described above includes the protector 100 including the protector main body 101 that has the open protector opening portion 102 and is formed for the wiring member W to be inserted therethrough, the protector cover 130 provided on the protector main body 101 via the hinge portion 107 in an openable-and-closable manner so as to cover the protector opening portion 102, and the protector-side lock portion 150 that locks the protector main body 101 and the protector cover 130, and the clamp 200 including the clamp main body 201 that is provided with the fixing portion 260 fixed to the object to be fixed V, has the open clamp opening portion 202, is attached to the outer periphery 101a of the protector main body 101, and is provided with the support portion 203 that supports the outer periphery 101a of the protector main body 101 so as to regulate a relative position around the axis CL of the protector main body 101 in the extending direction X of the wiring member W, the clamp cover 230 provided on the clamp main body 201 via the hinge portion 207 in an openable-and-closable manner so as to cover the clamp opening portion 202, and the clamp-side lock portion 250 that locks the clamp main body 201 and the clamp cover 230, in which the protector-side lock portion 150 and the clamp-side lock portion 250 are arranged to be aligned in position around the axis CL. The wire harness WH includes the wiring member W and the wiring member fixing device 1.

As a result, the protector-side lock portion 150 of the protector 100 and the clamp-side lock portion 250 of the clamp 200 are arranged to be aligned in position around the axis CL. Therefore, by setting the positions of the protector-side lock portion 150 and the clamp-side lock portion 250 around the axis CL to positions that are easy to visually recognize in a case in which the wiring member fixing device 1 is attached to the object to be fixed V, the worker can easily confirm locked states of the protector-side lock portion 150 and the clamp-side lock portion 250, and thus assembly workability can be improved.

In addition, the outer periphery 101a of the protector main body 101 has the arc-shaped portion 113 formed in an arc shape around the axis CL, and the restriction surface portion 114 connected to the arc-shaped portion 113 and formed in a flat surface shape in the height direction Z that is a direction intersecting the extending direction X, and the support portion 203 of the clamp main body 201 has the arc-shaped support portion 210 formed in an arc shape when viewed in the extending direction X so as to support the arc-shaped portion 113, and the abutment support surface portion 214 formed in a flat surface shape so as to abut on the restriction surface portion 114. As a result, the protector-side lock portion 150 and the clamp-side lock portion 250 can be arranged at positions around the set axis CL by abutment between the restriction surface portion 114 and the abutment support surface portion 214. Since the arc-shaped portion 113 is supported by the arc-shaped support portion 210, the protector 100 is restricted from moving around the axis CL and is reliably held by the clamp 200.

The restriction surface portion 114 and the abutment support surface portion 214 are provided at two places facing each other in the height direction Z that is a direction intersecting the extending direction X. Therefore, the clamp 200 is positioned around the axis CL with respect to the protector 100 such that the two restriction surface portions 114 are sandwiched between the two abutment support surface portions 214.

The arc-shaped support portion 210 of the clamp main body 201 includes the plurality of arc-shaped support ribs 213 formed in a rib shape. As a result, for example, even if the fixing portion 260 is provided outside the bottom plate portion 212 of the clamp main body 201, a portion between the plurality of arc-shaped support ribs 213 can be a cutout portion. Therefore, a degree of freedom in arrangement design of the fixing portion 260 is increased, and the protector-side lock portion 150 and the clamp-side lock portion 250 can be set at positions where it is easier to visually recognize the protector-side lock portion 150 and the clamp-side lock portion 250 when the wiring member fixing device 1 is attached to the object to be fixed V.

Further, on the outer periphery 101a of the protector main body 101, the long rectangular placement ribs 103 having plate surfaces oriented in the extending direction X are provided at two places with a predetermined interval therebetween in the extending direction X, and the clamp 200 is provided between the two placement ribs 103. As a result, for example, the protector 100 can be placed on the jig plate BJ, and the wiring member W can be easily inserted with the protector opening portion 102 oriented upward. Since the clamp 200 is provided between the placement ribs 103, it is possible to reduce interference when the clamp 200 is attached to the protector 100.

The wiring member fixing method includes the protector attachment step (Step S1) and the clamp attachment step (Step S2). As a result, the wiring member fixing device 1 can be assembled with and fixed to the object to be fixed V in a state in which the positions of the protector-side lock portion 150 and the clamp-side lock portion 250 are aligned.

In the protector attachment step (Step S2), the placement rib 103 is caused to abut on the jig plate BJ, and the protector 100 is placed on the jig plate BJ with the protector opening portion 102 facing the opposite side of the jig plate BJ. As a result, the protector opening portion 102 can be oriented upward, and the wiring member W can be easily inserted.

Note that the wiring member fixing device, the wire harness, and the wiring member fixing method according to the above-described embodiment of the present invention are not limited to the above-described embodiment, and various modifications can be made within the scope described in the claims.

In the above description, the object to be fixed V is, for example, a vehicle body of a vehicle, a member attached to the vehicle body, or a component, but may be another member, component, or the like. The support portion 203 of the clamp 200 is formed to include the arc-shaped support portion 210 and the abutment support surface portion 214. However, as long as the protector-side lock portion 150 and the clamp-side lock portion 250 can be arranged to be aligned in position around the axis CL, the support portion 203 may have another form.

The wiring member fixing device, the wire harness, and the wiring member fixing method according to the present embodiment may be configured by appropriately combining the components of the embodiment and the modification described above.

A wiring member fixing device, a wire harness, and a wiring member fixing method according to the present embodiment have an effect of improving assembly workability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wiring member fixing device comprising:
a protector including a protector main body having an open protector opening portion, the protector main body being configured for a wiring member to be inserted therethrough, a protector cover provided on the protector main body via a hinge portion in an openable-and-closable manner so as to cover the protector opening portion, and a protector-side lock portion configured to lock the protector main body and the protector cover; and
a clamp including a clamp main body provided with a fixing portion fixed to an object to be fixed, the clamp main body having an open clamp opening portion, the clamp main body being attached to an outer periphery of the protector main body, the clamp main body including a support portion configured to support the outer periphery of the protector main body so as to regulate a relative position around an axis of the protector main body in an extending direction of the wiring member, a clamp cover provided on the clamp main body via a hinge portion in an openable-and-closable manner so as to cover the clamp opening portion, and a clamp-side lock portion configured to lock the clamp main body and the clamp cover, wherein
the protector-side lock portion and the clamp-side lock portion are arranged to be aligned in position around the axis.

2. The wiring member fixing device according to claim 1, wherein
the protector main body has an arc-shaped portion and a restriction surface portion formed on the outer periphery thereof, the arc-shaped portion being formed in an arc shape around the axis, the restriction surface portion being connected to the arc-shaped portion and being formed in a flat surface shape in a direction intersecting the extending direction, and
the support portion of the clamp main body has an arc-shaped support portion formed in an arc shape when viewed in the extending direction so as to support the arc-shaped portion, and an abutment support surface portion formed in a flat surface shape so as to abut on the restriction surface portion.

3. The wiring member fixing device according to claim 2, wherein
the restriction surface portion and the abutment support surface portion are provided at two places facing each other in the direction intersecting the extending direction.

4. The wiring member fixing device according to claim 2, wherein
the arc-shaped support portion of the clamp main body includes a plurality of arc-shaped support ribs each formed to have a rib shape.

5. The wiring member fixing device according to claim 1, wherein
the protector main body has long rectangular-shaped placement ribs having plate surfaces oriented in the extending direction, the placement ribs being provided at two places on the outer periphery of the protector main body with a predetermined interval therebetween in the extending direction, and
the clamp is provided between the two placement ribs.

6. The wiring member fixing device according to claim 2, wherein
the protector main body has long rectangular-shaped placement ribs having plate surfaces oriented in the extending direction, the placement ribs being provided at two places on the outer periphery of the protector main body with a predetermined interval therebetween in the extending direction, and
the clamp is provided between the two placement ribs.

7. The wiring member fixing device according to claim 3, wherein
the protector main body has long rectangular-shaped placement ribs having plate surfaces oriented in the extending direction, the placement ribs being provided at two places on the outer periphery of the protector main body with a predetermined interval therebetween in the extending direction, and
the clamp is provided between the two placement ribs.

8. The wiring member fixing device according to claim 4, wherein
the protector main body has long rectangular-shaped placement ribs having plate surfaces oriented in the extending direction, the placement ribs being provided at two places on the outer periphery of the protector main body with a predetermined interval therebetween in the extending direction, and
the clamp is provided between the two placement ribs.

9. A wire harness comprising:
a wiring member having conductivity; and
a wiring member fixing device configured to fix the wiring member to an object to be fixed, wherein
the wiring member fixing device includes
a protector including a protector main body having an open protector opening portion, the protector main body being configured for the wiring member to be inserted therethrough, a protector cover provided on the protector main body via a hinge portion in an openable-and-closable manner so as to cover the protector opening portion, and a protector-side lock portion configured to lock the protector main body and the protector cover, and
a clamp including a clamp main body provided with a fixing portion fixed to the object to be fixed, the clamp main body having an open clamp opening portion, the clamp main body being attached to an outer periphery of the protector main body, the clamp main body including a support portion configured to support the outer periphery of the protector main body so as to regulate a position around an axis of the protector main body in an extending direction of the wiring member, a clamp cover provided on the clamp main body via a hinge portion in an openable-and-closable manner so as to cover the clamp opening portion, and a clamp-side lock portion configured to lock the clamp main body and the clamp cover, and
the protector-side lock portion and the clamp-side lock portion are arranged to be aligned in position around the axis.

10. A wiring member fixing method comprising:
a protector attachment step of placing, on a jig plate, a protector including a protector main body having an open protector opening portion, the protector main body being configured for a wiring member to be inserted therethrough, inserting the wiring member through the protector main body from the protector opening portion, closing a protector cover provided on the protector main body via a hinge portion in an openable-and-closable manner to cover the protector opening portion, and locking the protector main body and the protector cover with a protector-side lock portion provided on the protector; and
a clamp attachment step of inserting the protector main body of the protector from a clamp opening portion formed to be open in a clamp main body of a clamp to attach the clamp main body to the protector main body, supporting an outer periphery of the protector main body by a support portion provided in the clamp main body so as to regulate a position around an axis of the protector main body in an extending direction of the wiring member, closing a clamp cover provided on the clamp main body via a hinge portion in an openable-and-closable manner to cover the clamp opening portion, locking the clamp main body and the clamp cover by a clamp-side lock portion provided in the clamp, and arranging the protector-side lock portion and the clamp-side lock portion to be aligned in position around the axis.

11. The wiring member fixing method according to claim 10, wherein
the protector main body has rectangular-shaped placement ribs having plate surfaces oriented in the extending direction, the placement ribs being provided at two places on the outer periphery of the protector main body with a predetermined interval therebetween in the extending direction, and
in the protector attachment step, the placement ribs are caused to abut on the jig plate, and the protector is placed on the jig plate with the protector opening portion facing an opposite side of the jig plate.
